(19) United States
(12) Patent Application Publication
(10) Pub. No.: US 2018/0314951 A1
(43) Pub. Date: Nov. 1, 2018

(54) REASONING SYSTEM, REASONING METHOD, AND RECORDING MEDIUM

(71) Applicant: NEC CORPORATION, Tokyo (JP)

(72) Inventors: Kunihiko SADAMASA, Tokyo (JP); Takashi ONISHI, Tokyo (JP); Kentarou SASAKI, Tokyo (JP); Yotaro WATANABE, Tokyo (JP); Kai ISHIKAWA, Tokyo (JP); Satoshi MORINAGA, Tokyo (JP)

(73) Assignee: NEC CORPORATION, Tokyo (JP)

(21) Appl. No.: 15/772,678

(22) PCT Filed: Nov. 10, 2015
(86) PCT No.: PCT/JP2015/005599

§ 371 Date: May 1, 2018

(51) Int. Cl. G06N 5/02; G06N 5/04

(52) U.S. Cl. CPC G06N 5/025; G06N 5/04

(57) ABSTRACT

A reasoning system that enables reasoning when there is a shortage of knowledge. An input unit receives a start state and an end state. A rule candidate generation unit identifies a first state, obtained by tracking one or more known rules from the start state, and a second state, obtained by backtracking one or more known rules from the end state, respectively. The generation unit generates a rule candidate relating to the first state and the second state or generates a rule candidate relating to the first state and a rule candidate relating to the second state. A rule selection unit selects, based on feasibility of the generated rule candidate, which is calculated based on one or more known rules, the generated rule candidate as a new rule. A derivation unit derives the end state from the start state, based on one or more known rules and the new rule.

### TECHNICAL FIELD

The present invention relates to a reasoning system, a reasoning method, and a program, and, in particular, to a reasoning system, a reasoning method, and a recording medium for performing reasoning based on knowledge.

### BACKGROUND ART

Realization of artificial intelligence that thinks like a human and performs decision making on behalf of a human is being sought. As a technique relating to artificial intelligence, there is used a technique for assisting human decision making by performing determination about a state or the like, based on knowledge, and outputting a basis for the determination.

As a technique for assisting such decision making, reasoning based on first-order predicate logic (FOL) is known.

For example, as open source software (OSS) for reasoning based on FOL, Prolog as described in NPL 1 is known. In Prolog, knowledge (hereinafter also referred to as rules) representing a relation between states and a start state (for example, an observed state) of reasoning are given in advance. A rule represents a relation such as “if state A is true, then state B is true”, for example. When an end state of the reasoning is input, an answer is provided as to whether the end state can be derived from the start state by tracking one or more rules. In addition, a basis thereof is presented as a derivation tree.

FIG. 25 is a diagram illustrating an example of reasoning by Prolog. In FIG. 25, a circle represents a state and an arrow between circles represents a rule. For example, in FIG. 25, when a start state “Fuel piping is damaged” and an end state “Fuel valve closes” are specified by a user, a possibility that the end state can be derived from the start state and a derivation tree indicating rules from the start state to the end state are output. This allows the user to know a possibility that a cause of the end state “Fuel valve closes” is the start state “Fuel piping is damaged” and a basis thereof.

As another technique for reasoning based on FOL, reasoning based on Markov logic network (MLN) as described in NPL 2 is known. In the MLN, reasoning that allows probabilistic satisfaction of a first-order predicate logic is performed.

Note that NPL 3 discloses a technique for learning a model for determining semantic sameness between documents.

### CITATION LIST

### Non Patent Literature

NPL 1: “Prolog”, [online], [retrieved on Oct. 26, 2015], Internet <URL: https://ja.wikipedia.org/wiki/Prolog>
NPL 2: Matthew Richardson, et. al, “Markov Logic Networks”, Machine Learning, Vol. 62 (1-2), pp. 107-136, 2006
NPL 3: Bin Bai, et. al, “Supervised Semantic Indexing”, Proceedings of the 18th ACM conference on Information and knowledge management, pp. 187-196, 2009

### SUMMARY OF INVENTION

### Technical Problem

However, when reasoning is performed by using Prolog as described in NPL 1, an answer may not be obtained (fails to reason) when there is a shortage or lack of knowledge (rules). For example, when a start state is “Temperature is sub-zero” in FIG. 25, the end state “Fuel valve closes” cannot be derived even by tracking one or more rules from the start state “Temperature is sub-zero”. Accordingly, no cause of the end state “Fuel valve closes” can be identified.

Further, when reasoning is performed by using Prolog, only a basis that is obtained from known rules can be presented, thus making it difficult to support conception of a new idea (finding). FIG. 26 is a diagram illustrating another example of the reasoning by Prolog. In FIG. 26, when a start state “Select route A” and an end state “Arrive earlier”, for example, are specified, a possibility that the end state can be derived from the start state and a derivation tree from the start state to the end state are output. However, they are a well-known answer and basis, and do not lead to support of the conception of a new idea.

When the MLN described in NPL 2 is used for reasoning, the probabilistic reasoning can be performed even when there is a shortage or lack of rules to some extent. However, a derivation tree from a start state to an end state is not output and interpretability of a basis is low because of incompleteness of the derivation tree.

An object of the present invention is to solve the issues described above and provide a reasoning system, a reasoning method, and a recording medium that enable reasoning even when there is a shortage or lack of knowledge (rules).

### Solution to Problem

A first reasoning system according to an exemplary aspect of the present invention includes: input means for receiving input of a start state and an end state; rule candidate generation means for identifying a first state that is obtained by tracking one or more known rules from the start state and a second state that is obtained by backtracking one or more known rules from the end state, respectively, and generating a rule candidate relating to the first state and the second state or generating a rule candidate relating to the first state and a rule candidate relating to the second state; rule selection means for selecting, based on feasibility of the generated rule candidate, the generated rule candidate as a new rule, the feasibility being calculated based on one or more known rules; and derivation means for performing a derivation process that derives the end state from the start state, based on one or more known rules and the new rule.

A first reasoning method according to an exemplary aspect of the present invention includes: receiving input of a start state and an end state; identifying a first state that is obtained by tracking one or more known rules from the start state and a second state that is obtained by backtracking one or more known rules from the end state, respectively, and generating a rule candidate relating to the first state and the second state or generating a rule candidate relating to the first state and a rule candidate relating to the second state; selecting, based on feasibility of the generated rule candidate, the generated rule candidate as a new rule, the feasibility being calculated based on one or more known rules; and performing a derivation process that derives the end state from the start state, based on one or more known rules and the new rule.

A first computer readable storage medium according to an exemplary aspect of the present invention records thereon a program causing a computer to perform a method including: receiving input of a start state and an end state; identifying a first state that is obtained by tracking one or more known rules from the start state and a second state that is obtained by backtracking one or more known rules from the end state, respectively, and generating a rule candidate relating to the first state and the second state or generating a rule candidate relating to the first state and a rule candidate relating to the second state; selecting, based on feasibility of the generated rule candidate, the generated rule candidate as a new rule, the feasibility being calculated based on one or more known rules; and performing a derivation process that derives the end state from the start state, based on one or more known rules and the new rule.

A second reasoning system according to an exemplary aspect of the present invention includes: input means for receiving input of a start state and an end state; risk state identifying means for identifying a risk state for the end state; and derivation means for performing a derivation process that derives the risk state from the start state, based on one or more known rules.

A second reasoning method according to an exemplary aspect of the present invention includes: receiving input of a start state and an end state; identifying a risk state for the end state; and performing a derivation process that derives the risk state from the start state, based on one or more known rules.

A second computer readable storage medium according to an exemplary aspect of the present invention records thereon a program causing a computer to perform a method including: receiving input of a start state and an end state; identifying a risk state for the end state; and performing a derivation process that derives the risk state from the start state, based on one or more known rules.

### Advantageous Effects of Invention

An advantageous effect of the present invention is that reasoning can be performed even when there is a shortage or lack of knowledge.

### BRIEF DESCRIPTION OF DRAWINGS

FIG. 1 is a block diagram illustrating a configuration of a first example embodiment of the present invention;

FIG. 2 is a block diagram illustrating a configuration of a reasoning system 100 implemented by a computer according to the first example embodiment of the present invention;

FIG. 3 is a flowchart illustrating operation of the first example embodiment of the present invention;

FIG. 4 is a diagram illustrating an example of domain knowledge 161 according to the first example embodiment of the present invention;

FIG. 5 is a diagram illustrating examples of rules other than the domain knowledge 161 according to the first example embodiment of the present invention;

FIG. 6 is a diagram illustrating an example of generation of rule candidates according to the first example embodiment of the present invention;

FIG. 7 is a diagram illustrating an example of selection of a new rule according to the first example embodiment of the present invention;

FIG. 8 is a diagram illustrating an example of an output screen 151 according to the first example embodiment of the present invention;

FIG. 9 is a block diagram illustrating a characteristic configuration of the first example embodiment of the present invention;

FIG. 10 is a block diagram illustrating a configuration of a second example embodiment of the present invention;

FIG. 11 is a flowchart illustrating operation of the second example embodiment of the present invention;

FIG. 12 is a diagram illustrating an example of domain knowledge 161 according to the second example embodiment of the present invention;

FIG. 13 is a diagram illustrating an example of generation of rule candidates according to the second example embodiment of the present invention;

FIG. 14 is a diagram illustrating an example of determination of a new rule according to the second example embodiment of the present invention;

FIG. 15 is a diagram illustrating an example of an output screen 151 according to the second example embodiment of the present invention;

FIG. 16 is a diagram illustrating another example of the domain knowledge 161 according to the second example embodiment of the present invention;

FIG. 17 is a diagram illustrating another example of generation of rule candidates according to the second example embodiment of the present invention;

FIG. 18 is a diagram illustrating another example of determination of a new rule according to the second example embodiment of the present invention;

FIG. 19 is a diagram illustrating another example of the output screen 151 according to the second example embodiment of the present invention;

FIG. 20 is a diagram illustrating yet another example of the domain knowledge 161 according to the second example embodiment of the present invention;

FIG. 21 is a diagram illustrating yet another example of generation of rule candidates according to the second example embodiment of the present invention;

FIG. 22 is a diagram illustrating yet another example of determination of a new rule according to the second example embodiment of the present invention;

FIG. 23 is a diagram illustrating yet another example of the output screen 151 according to the second example embodiment of the present invention;

FIG. 24 is a block diagram illustrating a characteristic configuration of the second example embodiment of the present invention;

FIG. 25 is a diagram illustrating an example of reasoning by Prolog; and

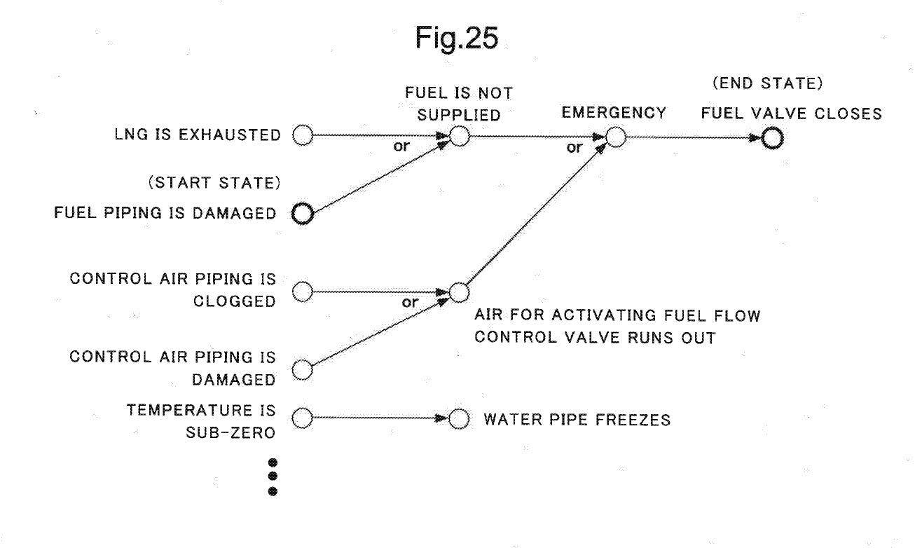

FIG. 26 is a diagram illustrating another example of reasoning by Prolog.

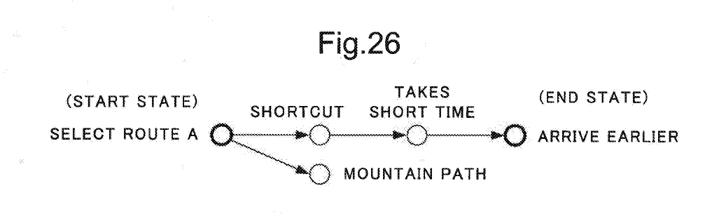

### DESCRIPTION OF EMBODIMENTS

Example embodiments of the present invention will be described in detail with reference to the drawings. Note that, in the drawings and example embodiments described herein, the same reference sign is given to similar components, and description of those components will be omitted as appropriate.

### First Example Embodiment

A first example embodiment of the present invention will be described.

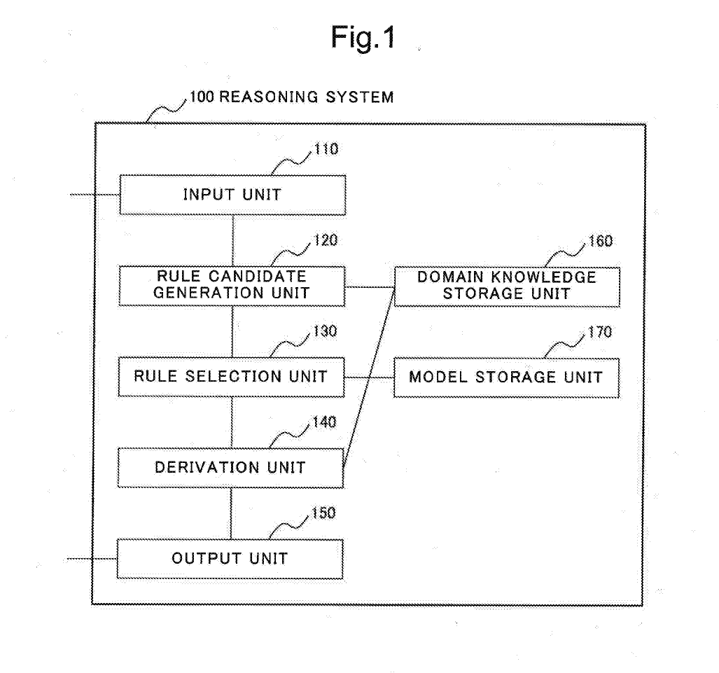

A configuration of the first example embodiment of the present invention will be described first. FIG. 1 is a block diagram illustrating a configuration of the first example embodiment of the present invention. Referring to FIG. 1, a reasoning system 100 of the first example embodiment of the present invention includes an input unit 110, a rule candidate generation unit 120, a rule selection unit 130, a derivation unit 140, an output unit 150, a domain knowledge storage unit 160, and a model storage unit 170.

The domain knowledge storage unit 160 stores domain knowledge 161. The domain knowledge 161 is a set of known knowledge (rules) representing relations between states, actions and events relating to a target region (domain) for reasoning. Such states, actions and events will be hereinafter collectively referred to as “states”. The state is represented like “x eats y”, for example, by using a predicate (“eats” in this case) and arguments (x and y in this case) which are targets for describing states. A rule has a form “If state A is true (premise), then state B is true (conclusion)” and represents an implication relation, a causal relation, a contextual relation, an If-then relation, or the like between states. A rule “If state A is true, then state B is true” will be also denoted as a rule “A→B” hereinafter. In this case, states A and B are also referred to as “states relating to the rule” and the rule will be also referred to as a “rule relating to states A and B”, a “rule relating to state A”, or a “rule relating to state B”. When there are rule 1 “If state A is true, then state B is true” and rule 2 “If state B is true, then state C is true”, state C can be derived from state A by tracking rule 1 and rule 2. In this case, a derivation tree that can be obtained by tracking rule 1 and rule 2 will be also denoted as a derivation tree “A→B→C”. Note that the domain knowledge 161 may include known rules widely collected from those other than the domain.

States and rules are described in first-order predicate logic, for example. As long as a relation such as “If state A is true, then state B is true” as described above can be treated as a relation between states, states and rules may also be described in propositional logic, higher-order predicate logic, or any other form. The domain knowledge 161 is set in advance by a user, an administrator, or the like (hereinafter simply referred to as a user), for example.

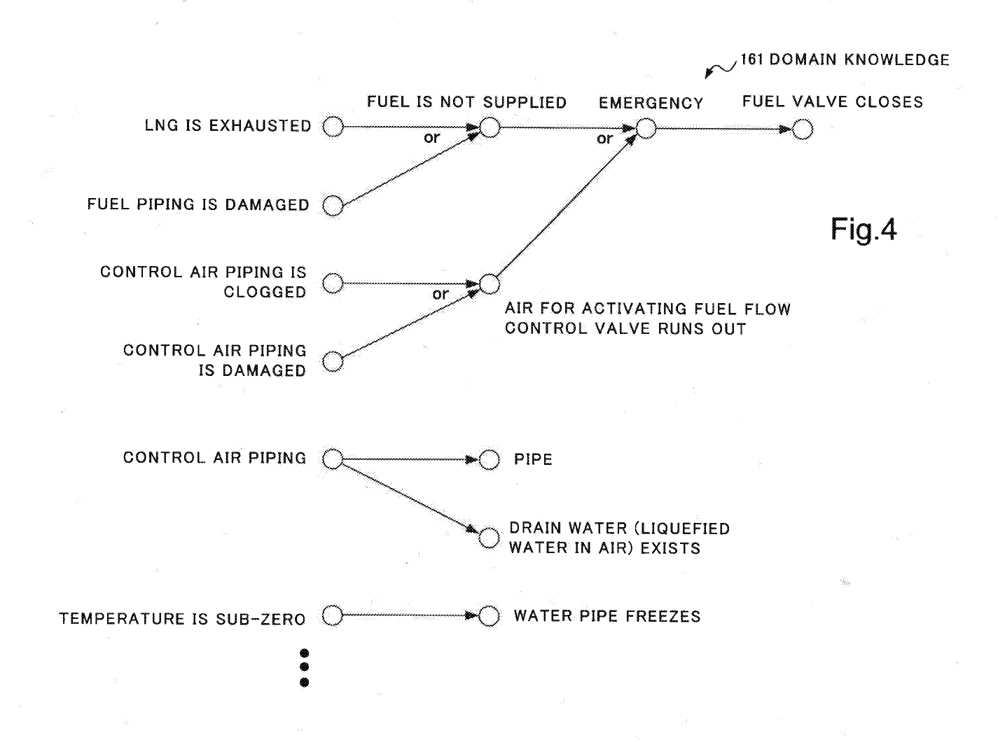

FIG. 4 is a diagram illustrating an example of the domain knowledge 161 according to the first example embodiment of the present invention. In FIG. 4, a circle represents a state and an arrow between circles represents a rule, where a state at a source of the arrow is a premise and a state at a head of the arrow is a conclusion. Note that while one state or a logical add (OR) of a plurality of states is included as a premise of a rule in the example in FIG. 4, a logical multiplication (AND) of a plurality of states may also be included as the premise.

The input unit 110 receives input of a start state and an end state of reasoning from a user. The start state is a state used as a premise of the reasoning. The start state may be a state being observed (an observed state). The end state is a state used as a conclusion of the reasoning, which is to be derived based on the start state. The end state may be a state of a target for the user (a target state). The start state and the end state are specified from among states included in the domain knowledge 161, for example.

The input unit 110 converts a start state and an end state given in natural text, for example, to first-order predicate logic. Alternatively, the input unit 110 may be connected to various sensors (not depicted) and may receive information collected from the sensors as a start state and an end state. In this case, the input unit 110 converts information collected from the sensors to first-order predicate logic, for example.

The rule candidate generation unit 120 generates rule candidates based on the input start state, the input end state and the domain knowledge 161. A rule candidate is a candidate for a rule for deriving the end state from the start state, which does not exist in the domain knowledge 161.

The model storage unit 170 stores a model 171 learned from relations between states relating to known rules. The model 171 is learned based on rules included in the domain knowledge 161 stored in the domain knowledge storage unit 160, for example. The model 171 may be learned based on known rules collected widely other than the domain knowledge 161, in addition to the rules included in the domain knowledge 161.

The rule selection unit 130 calculates a score indicating feasibility (a feasibility score) by using the model 171 stored in the model storage unit 170, for each of the generated rule candidates, and selects a new rule based on the calculated feasibility scores.

The derivation unit 140 performs a derivation process that derives an end state from a start state by using the domain knowledge 161 and the selected new rule. In the derivation process, determination is made as to whether or not the end state can be derived from the start state. In addition, a derivation tree indicating rules from the start state to the end state is generated in the derivation process.

The output unit 150 outputs (displays) a result of determination (a result of reasoning) by the derivation unit 140 to the user.

Note that the reasoning system 100 may be a computer that includes a central processing unit (CPU) and a storage medium on which a program is stored, and operates under control based on the program.

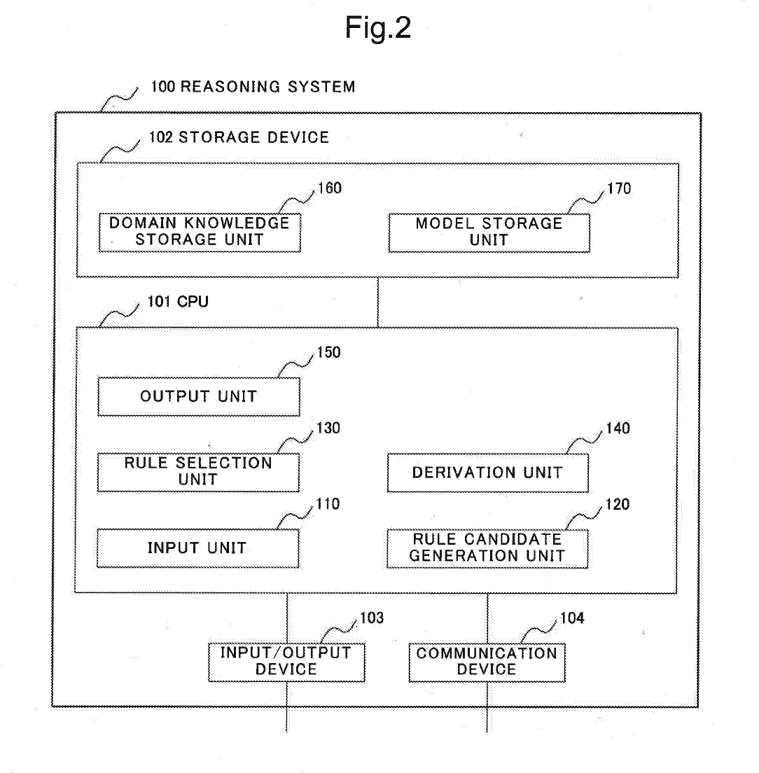

FIG. 2 is a block diagram illustrating a configuration of the reasoning system 100 implemented by a computer according to the first example embodiment of the present invention.

The reasoning system 100 in this case includes a CPU 101, a storage device 102 (a storage medium) such as a hard disk or a memory, an input/output device 103 such as a keyboard or a display, and a communication device 104 that communicates with other apparatuses or the like. The CPU 101 executes a program for implementing the input unit 110, the rule candidate generation unit 120, the rule selection unit 130, the derivation unit 140 and the output unit 150. The storage device 102 stores data in the domain knowledge storage unit 160 and the model storage unit 170. The input/output device 103 inputs a start state and an end state from a user, and outputs a result of reasoning to the user. The communication device 104 may receive a start state and an end state from another apparatus or the like, or may send a result of reasoning to another apparatus or the like.

A reasoning service by the reasoning system 100 may be provided to the user in the form of Software as a Service (SaaS).

A part or the whole of the components of the reasoning system 100 in FIG. 1 may be implemented by general or dedicated circuitry, a general or dedicated processor, or a combination of them. The circuitry or the processor may be formed by a single chip or may be formed by a plurality of chips interconnected through a bus. Further, a part or the whole of the components of the reasoning system 100 may be implemented by a combination of the circuitry or the like and a program.

In a case where a part or the whole of the components of the reasoning system 100 in FIG. 1 are implemented by a plurality of information processing apparatuses or a plurality of pieces of circuitry or the like, the plurality of information processing apparatuses or the plurality of pieces of circuitry or the like may be arranged in a centralized manner or distributed manner. For example, the information processing apparatuses or the pieces of circuitry or the like may be implemented in a form such as a client-server system, a cloud computing system or the like, in which the information processing apparatuses or the pieces of circuitry or the like are connected through a communication network.

The operation of the first example embodiment of the present invention will be described next.

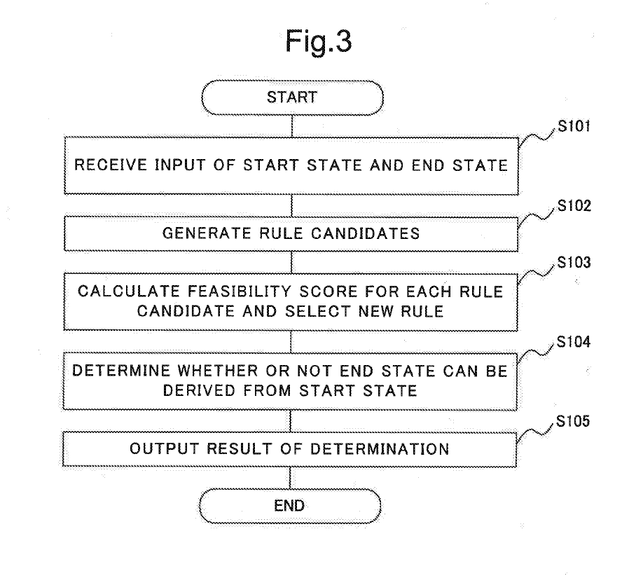

FIG. 3 is a flowchart illustrating the operation of the first example embodiment of the present invention.

First, the input unit 110 receives input of a start state and an end state (step S101).

The rule candidate generation unit 120 generates rule candidates based on the start state and the end state input in step S101 and the domain knowledge 161 (step S102).

In this step, the rule candidate generation unit 120 identifies, in the domain knowledge 161, a state (a first state) that can be derived by tracking one or more rules from the start state in a forward direction (a direction from a premise to a conclusion). Further, the rule candidate generation unit 120 identifies, in the domain knowledge 161, a state (a second state) from which the end state can be derived by tracking (backtracking) one or more rules from the end state in a backward direction (a direction from a conclusion to a premise). The rule candidate generation unit 120 then generates rule candidates that have the first state as a premise and the second state as a conclusion for each combination of the first state and the second state. Note that no rule candidate is generated for a combination including a negated state.

The rule selection unit 130 calculates a feasibility score for each of the rule candidates generated in step S102 by using a model 171 stored in the model storage unit 170, and selects a new rule based on the calculated feasibility scores (step S103). The rule selection unit 130 selects a rule candidate that has a feasibility score equal to or more than a predetermined threshold as a new rule.

For example, the rule selection unit 130 calculates a feasibility score, based on a similarity of a relation between states relating to the rule candidate to a relation between states relating to a known rule represented by the model 171.

As a method for calculating such a feasibility score, for example, a technique described in NPL 3 or a technique for calculating a similarity of states between a rule candidate and a known rule is used.

When the technique described in NPL 3 is used, the rule selection unit 130 calculates a feasibility score of a rule candidate by using vectors representing states relating to the rule candidate and a weighting matrix stored as a model 171 in the model storage unit 170. In this case, a feasibility score between states A and B is calculated by using vectors V_{A} and V_{B} representing states A and B, respectively, and a weighting matrix W, as V_{A}^{T}·W·V_{B} (^{T} represents a transpose). The vectors V_{A} and V_{B} are D-dimensional vectors in which each element corresponds to each word in a word dictionary containing D words, for example. Each element represents presence or absence of a corresponding word in the description of states A and B. The weighting matrix W is a D×D dimensional matrix. The weighting matrix W is learned by using known rules such as the domain knowledge 161 in such a way that a high feasibility score is calculated for the known rules.

When the technique for calculating a similarity of states between a rule candidate and a known rule is used, the rule selection unit 130 compares a premise state and a conclusion state of a rule candidate with a premise state and a conclusion state of a rule stored as the model 171 in the model storage unit 170, respectively. In the comparison between states, predicates and arguments are compared, respectively. For example, it is assumed that a rule “A→B” (state A: “x eats y”, state B: “x feels satisfaction”) exists in the model storage unit 170 and a rule candidate “A1→B1” (state A1: “x1 sips y1”, state B1: “x1 feels delight”) is generated. In this case, the rule selection unit 130 compares x with x1, “eats” with “sips”, y with y1, and “feels satisfaction” with “feels delight”, and calculates similarities between them as a feasibility score for the rule candidate “A1-B1”. Rules used as the model 171 may be known rules included in the domain knowledge 161 or may be known rules widely collected. In this case, the rule selection unit 130 calculates a similarity to a most similar rule as the feasibility score, for example. Rules used as the model 171 may be generated, for example, by generalizing predicates and arguments in states relating to similar rules or representing them in a broader concept, based on known rules included in the domain knowledge 161 or known rules widely collected.

The derivation unit 140 determines whether or not the end state can be derived from the start state by using the domain knowledge 161 and the new rule selected in step S103 (step S104). In this step, the derivation unit 140 may perform deductive reasoning or abductive reasoning by using the domain knowledge 161 and the new rule. The derivation unit 140 may perform reasoning based on MLN described above, probabilistic soft logic (PSL) or the like by using the domain knowledge 161 and the new rule.

Lastly, the derivation unit 140 outputs (displays) a result of determination (a result of reasoning) by the derivation unit 140 to a user through the output unit 150 (step S105). In this step, the derivation unit 140 may output a derivation tree from the start state to the end state along with the result of reasoning. In a case where reasoning that is capable of outputting likelihood of the result of reasoning as a score, exemplified by statistical reasoning such as MLN and PSL, is performed, the output unit 150 may output a score (reasoning score) relating to a result of reasoning obtained by such reasoning along with the result of reasoning.

With this, the operation of the first example embodiment of the present invention has been completed.

A specific example of the operation of the first example embodiment of the present invention will be described next.

<Specific Example: Infrastructure Operations Support>

A specific example of infrastructure operations support by the reasoning system 100 will be described here.

Shutdown of facilities such as a power plant and a waterworks system has a large impact on social infrastructure. Therefore, a support (infrastructure operations support) by a machine is desirable especially in a situation where it is difficult to make a determination only by humans. The support by a machine is, for example, reading a current situation from values of various sensors and presenting an operation procedure for improving the situation along with a reason thereof, by the machine.

An example will be described here in which the reasoning system 100 performs an operation support for a thermal power plant using liquefied natural gas (LNG), as an infrastructure operation support. For example, it is assumed that the thermal power plant is not supplied with fuel LNG and power generation has shut down. At this point, a fuel valve for controlling fuel supply is closed. While an operation manual states that a fuel valve closes when an abnormality occurs in fuel supply, exhaustion of LNG or damage to LNG piping or the like is not detected. The reasoning system 100 therefore reasons how start states collected by sensors or the like can lead to the end state “Fuel valve closes”

It is assumed here that the domain knowledge 161 as illustrated in FIG. 4 is described in a first-order predicate logic, and stored in the domain knowledge storage unit 160.

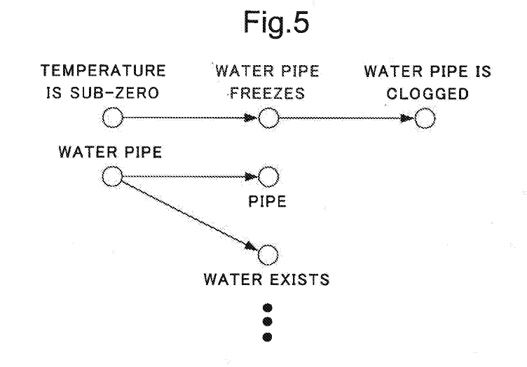

FIG. 5 is a diagram illustrating an example of rules other than the domain knowledge 161 according to the first example embodiment of the present invention. In the example in FIG. 5, rules relating to a water pipe is included as widely collected rules other than the domain knowledge 161.

It is assumed that a model 171 learned based on the domain knowledge 161 in FIG. 4 and widely collected rules in FIG. 5 are stored in the model storage unit 170. In this case, the model 171 has learned that a relation “Temperature is sub-zero→Pipe is clogged” is likely to be feasible as a rule, for example.

The input unit 110 receives input of states “temperature is sub-zero”, “¬ LNG is exhausted”, “¬ Fuel piping is damaged”, and “¬ Control air piping is damaged” collected by sensors or the like, as start states. Here, “¬” represents negation (for example, “¬ LNG is exhausted” represents that “LNG is not exhausted”). While the states on the domain knowledge 161 in FIG. 4 are indicated here, the input unit 110 may also receive other states collected by various sensors. In addition, the input unit 110 receives an input of “Fuel valve closes” as an end state from a user.

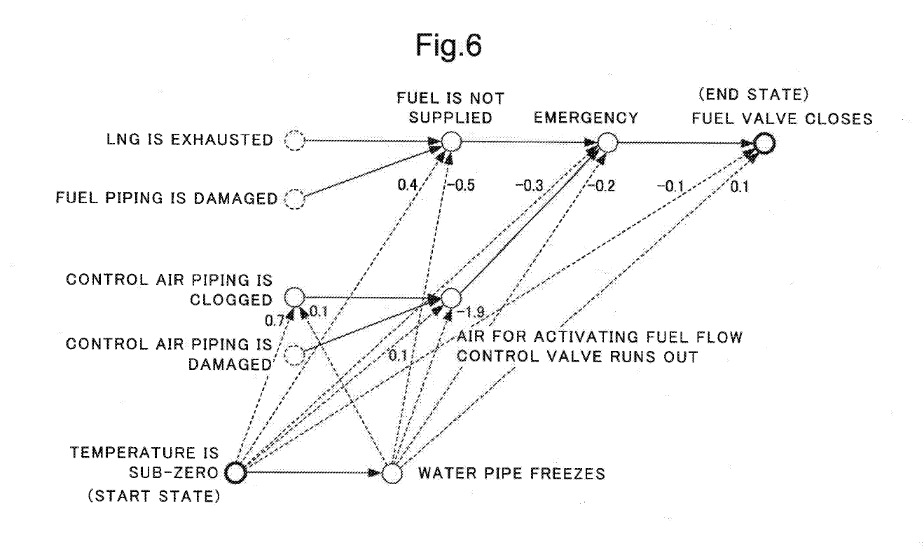

FIG. 6 is a diagram illustrating an example of generation of rule candidates according to the first example embodiment of the present invention. In FIG. 6, a circle with dashed line represents a state negated as a start state. An arrow with dashed line represents a generated rule candidate.

The rule candidate generation unit 120 identifies a state that can be obtained by tracking one or more rules from the start state “Temperature is sub-zero” in a forward direction and a state that can be obtained by tracking (backtracking) one or more rules from the end state “Fuel valve closes” in a backward direction. The rule candidate generation unit 120 then extracts each combination of the identified states as a rule candidate as illustrated in FIG. 6.

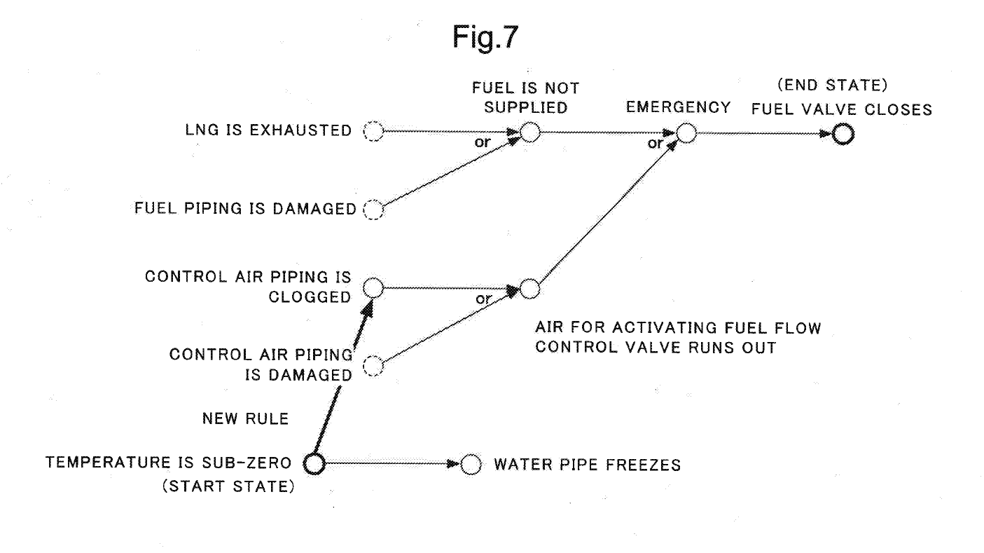

A numerical value given to a dashed line in FIG. 6 represents a feasibility score of a rule candidate. FIG. 7 is a diagram illustrating an example of selection of a new rule according to the first example embodiment of the present invention.

The rule selection unit 130 calculates a feasibility score for each rule candidate by using a model 171, as illustrated in FIG. 6. When a score threshold for determining that a rule candidate is feasible is “0.5”, the rule candidate generation unit 120 selects a rule candidate “Temperature is sub-zero→Control air piping is clogged” which has a feasibility score of “0.7” as a new rule, as illustrated in FIG. 7.

The derivation unit 140 determines that the end state “Fuel valve closes” can be derived by tracking the new rule and rules in the domain knowledge 161 from the start state “Temperature is sub-zero” in FIG. 7.

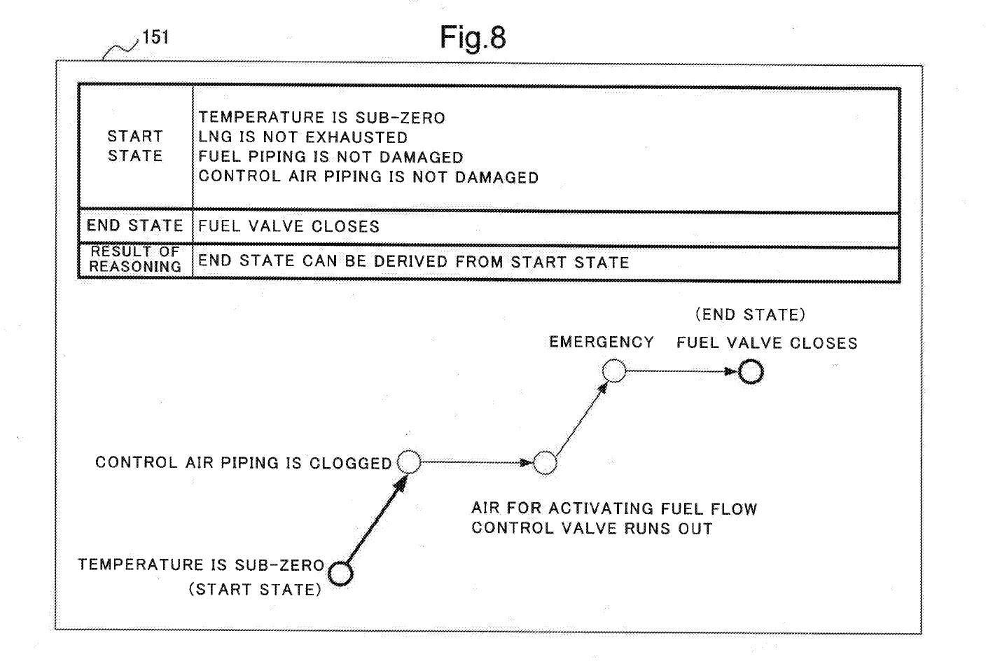

FIG. 8 is a diagram illustrating an example of an output screen 151 according to the first example embodiment of the present invention. In the example in FIG. 8, a possibility that the end state “Fuel valve closes” is derived from the start state “Temperature is sub-zero” and a derivation tree from the start state to the end state are displayed as a result of reasoning. In the derivation tree, each state is displayed in natural text converted from first-order predicate logic, for example. The start state, the end state and the new rule are highlighted and displayed by a thick line.

The output unit 150 displays the output screen 151 as illustrated in FIG. 8 to the user.

Note that the output unit 150 may display the start state, the end state, and the new rule in a color or shape that is different from that of the other states and known rules, as long as the start state, the end state and the new rule can be distinguished from the other states and the known rules.

This allows the user to know a possibility that the cause of the end state “Fuel valve closes” may be the start state “Temperature is sub-zero”, which cannot be obtained only from the known rules included in the domain knowledge 161, and the basis thereof.

The rule selection unit 130 selects a new rule based on the feasibility score in the first example embodiment of the present invention. However, rule selection is not limited to this. The rule selection unit 130 may present a rule candidate having a feasibility score equal to or more than the threshold to the user and may allow the user to input whether to select the rule candidate as a new rule. Further, the rule selection unit 130 may also present a rule candidate having a feasibility score less than the threshold to the user and may allow the user to input whether to select the rule candidate as a new rule. Such an input by the user may be repeated until the end state can be derived from the start state by the derivation unit 140 or until a condition that a reasoning score calculated by the derivation unit 140 is equal to or more than a predetermined threshold, the number of selections by the user is equal to or more than a predetermined threshold, or the like is satisfied.

In the first example embodiment of the present invention, the rule candidate generation unit 120 generates one rule candidate for each combination of a first state and a second state, where the first state is a premise and the second state is a conclusion. However, candidate rule generation is not limited to this. The rule candidate generation unit 120 may generate, for each of the combinations given above, a rule candidate in which a second state is derived from a first state through one or more other states. For example, in a case where there are states a and b as other states, rule candidates “A→a”, “a→B”, “A→b”, “b→B”, “a→b”, and “b→a” may be generated for a combination of a first state A and a second state B, in addition to a rule candidate “A→B”. For example, it is assumed here that the rule candidates “A→a”, “b→B” and “a→b” are selected as new rules from among these rule candidates based on feasibility scores. In this case, the derivation unit 140 uses a derivation tree “A→a→b→B” between states A and B to determine whether or not the end state can be derived from the start state. Note that the other states given above may be generated by the rule candidate generation unit 120 or the like combining a predicate and an argument of states included in the domain knowledge 161, for example. Alternatively, the other states may be predetermined states set by the user in advance.

In the first example embodiment of the present invention, an example has been described in which a start state and an end state are input by the user. However, the embodiment is not limited to this. Either a start state or an end state may be input by the user. When a start state is input, the reasoning system 100, by extracting an arbitrary state in the domain knowledge 161 as an end state, generating rule candidates and selecting a new rule, may determine whether the arbitrary state can be derived from the start state. Similarly, when an end state is input, the reasoning system 100, by extracting an arbitrary state in the domain knowledge 161 as a start state, generating rule candidates and selecting a new rule, may determine whether the end state can be derived from the arbitrary state.

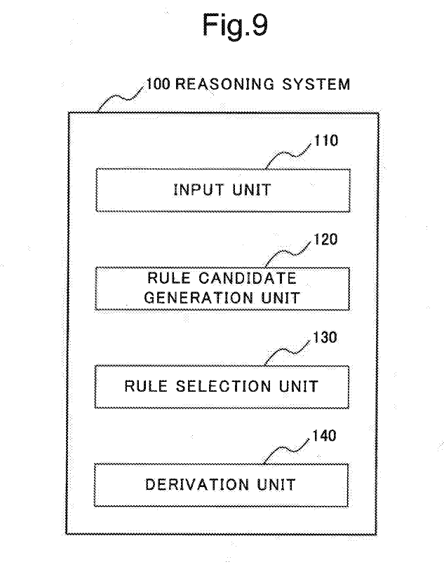

A characteristic configuration of the first example embodiment of the present invention will be described next. FIG. 9 is a block diagram illustrating a characteristic configuration of the first example embodiment of the present invention.

Referring to FIG. 9, a reasoning system 100 of the first example embodiment of the present invention includes an input unit 110, a rule candidate generation unit 120, a rule selection unit 130, and a derivation unit 140.

The input unit 110 receives input of a start state and an end state.

The rule candidate generation unit 120 identifies a first state that is obtained by tracking one or more known rules from the start state and a second state that is obtained by backtracking one or more known rules from the end state, respectively. The rule candidate generation unit 120 generates a rule candidate relating to the first state and the second state or generates a rule candidate relating to the first state and a rule candidate relating to the second state.

The rule selection unit 130 selects, based on feasibility of the generated rule candidate, which is calculated based on one or more known rules, the generated rule candidate as a new rule.

The derivation unit 140 performs a derivation process that derives the end state from the start state, based on one or more known rules and the new rule.

Advantageous effects of the first example embodiment of the present invention will be described next.

According to the first example embodiment of the present invention, reasoning can be performed even when there is a shortage or lack of knowledge (rules). This is because the reasoning system 100 generates rule candidates relating to a state that can be obtained by tracking one or more rules from a start state and a state that can be obtained by backtracking one or more rules from an end state, selects a new rule based on feasibilities of the rule candidates, and performs a derivation process. Thus, even in a case where an end state cannot be derived from a start state by using only known rules, whether or not the end state can be derived and a basis thereof can be presented, and thus a more correct reasoning result can be presented.

In general, when there is an enormous amount of knowledge (there are the enormous number of rules) on which reasoning is to be performed, it may take a huge amount of time to obtain a result of reasoning. According to the first example embodiment of the present invention, a result of reasoning can be obtained in a shorter time even when there is an enormous amount of knowledge. This is because the reasoning system 100 selects a new rule from among rule candidates relating to a state that can be obtained by tracking one or more rules from a start state and a state that can be obtained by backtracking one or more rules from an end state, and performs a derivation process on a derivation tree in which the selected new rule is used.

### Second Example Embodiment

A second example embodiment of the present invention will be described next.

The second example embodiment of the present invention differs from the first example embodiment of the present invention in that a risk state for an input end state is identified and the risk state is derived from a start state.

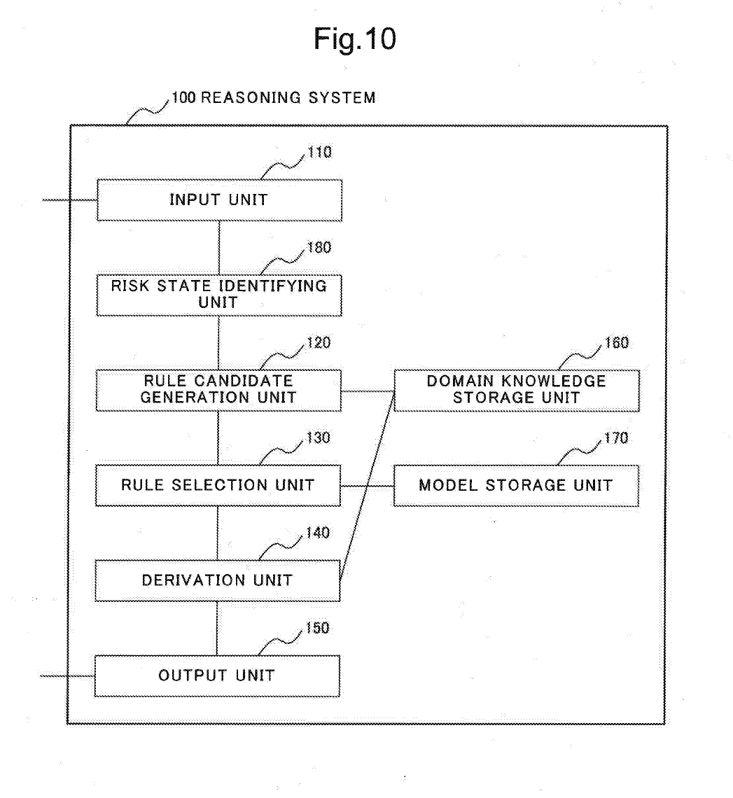

A configuration of the second example embodiment of the present invention will be described first. FIG. 10 is a block diagram illustrating a configuration of the second example embodiment of the present invention. Referring to FIG. 10, the reasoning system 100 of the second example embodiment of the present invention includes a risk state identifying unit 180 in addition to the configuration of the reasoning system 100 of the first example embodiment of the present invention.

The risk state identifying unit 180 identifies a risk state for an end state. The risk state is a state corresponding to a risk for the end state, such as a state that is a negation of the end state or a state that inhibits the end state.

The rule candidate generation unit 120 generates rule candidates for deriving a risk state from a start state in a way similar to that of the first example embodiment of the present invention.

The derivation unit 140 derives a risk state from a start state in a way similar to that of the first example embodiment of the present invention.

The operation of the second example embodiment of the present invention will be described next.

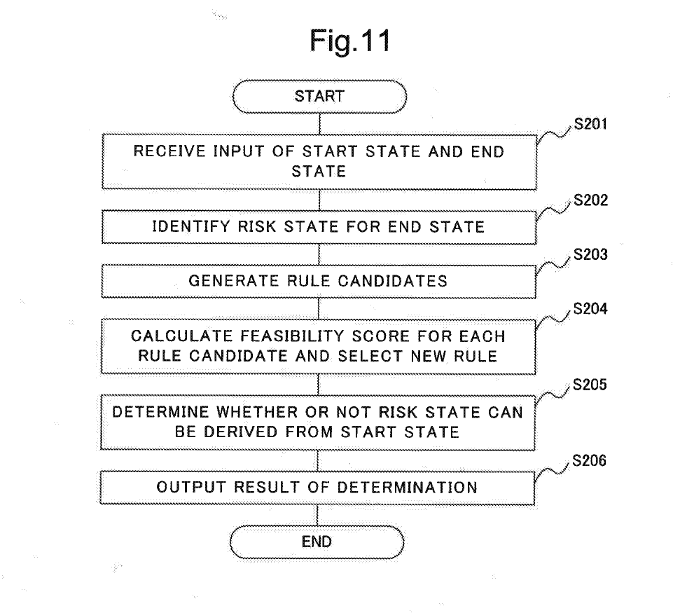

FIG. 11 is a flowchart illustrating the operation of the second example embodiment of the present invention.

First, the input unit 110 receives input of a start state and an end state (step S201).

The risk state identifying unit 180 identifies a risk state for the input end state (step S202). In this step, the risk state identifying unit 180 may set a state that is a negation of the input end state as the risk state. Alternatively, the risk state identifying unit 180 may identify a risk state for the end state based on risk states for states on the domain knowledge 161 stored in a domain knowledge storage unit 160 or the like in advance. Alternatively, the risk state identifying unit 180 may also use a risk state input by a user through the input unit 110.

The rule candidate generation unit 120 generates rule candidates based on the start state input in step S201, the risk state identified in step S202 and the domain knowledge 161 (step S203).

In this step, the rule candidate generation unit 120 identifies, in the domain knowledge 161, a state (a first state) that can be derived by tracking one or more rules from the start state in a forward direction. Further, the rule candidate generation unit 120 identifies, in the domain knowledge 161, a state (a second state) from which the risk state can be derived by tracking (backtracking) one or more rules from the risk state in a backward direction. The rule candidate generation unit 120 then generates rule candidates that have the first state as a premise and the second state as a conclusion for each combination of the first state and the second state.

The rule selection unit 130 calculates a feasibility score for each of the rule candidates generated in step S203 by using a model 171 stored in a model storage unit 170, and selects a new rule based on the calculated feasibility scores (step S204).

The derivation unit 140 determines whether or not the risk state can be derived from the start state by using the domain knowledge 161 and the new rule selected in step S204 (step S205). In this step, the derivation unit 140 may also determine whether or not the end state can be derived from the start state.

Lastly, the derivation unit 140 outputs (displays) a result of determination (result of reasoning) by the derivation unit 140 to the user through the output unit 150 (step S206). In this step, the derivation unit 140 may output a derivation tree from the start state to the risk state along with the result of reasoning. Further, the derivation unit 140 may also output a derivation tree from the start state to the end state. In this case, the output unit 150 may output the derivation tree from the start state to the risk state and the derivation tree from the start state to the risk state side by side.

With this, the operation of the second example embodiment of the present invention has been completed.

Specific examples of the operation of the second example embodiment of the present invention will be described next.

### Specific Example 1: Business Judgement Support

As specific example 1, an example of business judgement support by the reasoning system 100 will be described first.

It is assumed here that a business plan “In order to cut down production cost of product X, product X is produced in country A” has been designed. In this case, the user needs to know risks of the business plan.

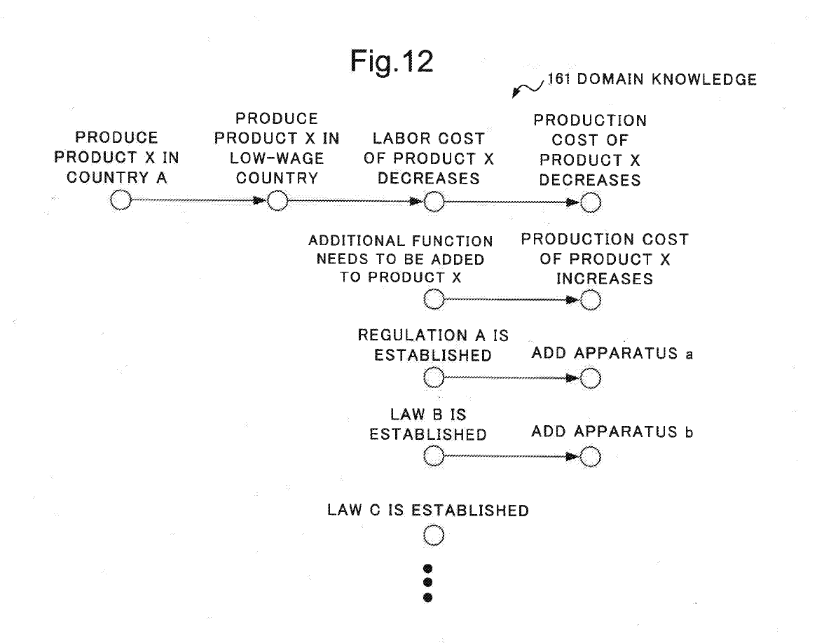

FIG. 12 is a diagram illustrating an example of domain knowledge 161 according to the second example embodiment of the present invention.

In a case where known rules in the domain knowledge 161 in FIG. 12 are used, a negation state for each of states in a derivation tree from a start state “Produce product X in country A” to an end state “Production cost of product X decreases” can be presented as a risk. For example, a risk “Goal cannot be achieved when there are no longer low wages in country A” can be presented.

However, such a risk can be readily found only from known rules written in the domain knowledge 161 and does not lead to a new finding. The reasoning system 100 therefore extracts and presents a new risk that cannot be found only from the known rules written in the domain knowledge 161, thereby supporting business judgement.

It is assumed here that the domain knowledge 161 illustrated in FIG. 12 is stored in the domain knowledge storage unit 160.

It is also assumed that a model 171 learned based on the domain knowledge 161 in FIG. 12 is stored in the model storage unit 170. In this case, the model 171 has learned that a relation between states, “Law or regulation is established→Compliance function needs to be added”, for example, is likely to be feasible as a rule.

The input unit 110 receives input of “Produce product X in country A” and “Law C is established” as start states from the user. The start state “Law C is established” may be generated by an input unit 110 regularly watching information sources such as news and official bulletins and extracting information from the information sources. The input unit 110 also receives an input of “Production cost of product X decreases” as an end state from the user. The input unit 110 sets a negation state “Production cost of product X increases” for the input end state as a risk state.

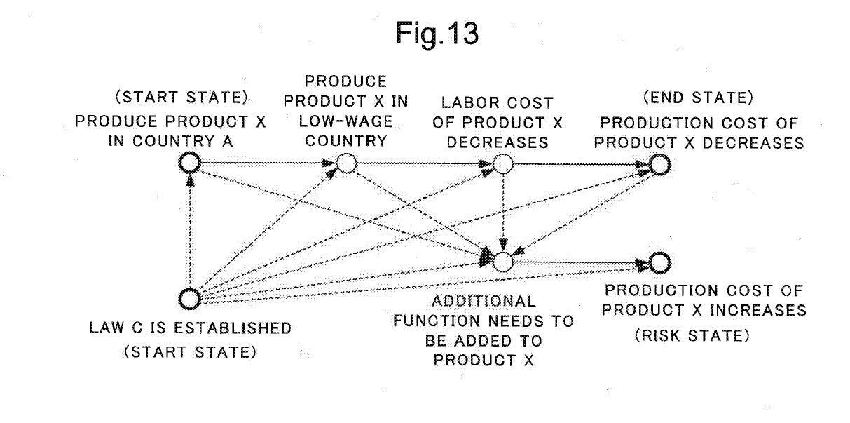

FIG. 13 is a diagram illustrating an example of generation of rule candidates in the second example embodiment of the present invention.

The rule candidate generation unit 120 identifies a state that can be obtained by tracking one or more rules from the start states “Produce product X in country A” and “Law C is established” in a forward direction, as illustrated in FIG. 13. The rule candidate generation unit 120 also identifies a state that can be obtained by tracking (backtracking) one or more rules from the risk state “Production cost of product X increases” in a backward direction. The rule candidate generation unit 120 extracts each combination of the identified states as a rule candidate.

The rule selection unit 130 calculates a feasibility score for each rule candidate by using the model 171.

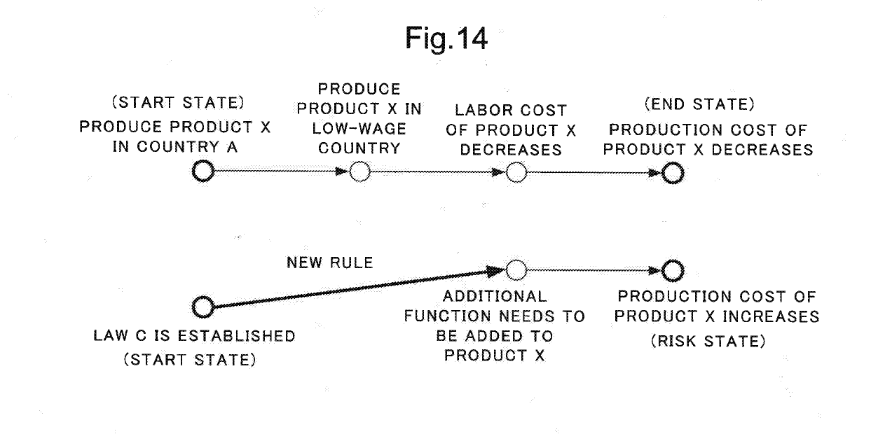

FIG. 14 is a diagram illustrating an example of determination of a new rule according to the second example embodiment of the present invention.

It is assumed here that a feasibility score equal to or more than a threshold has been calculated for a rule candidate “Law C is established→Additional function needs to be added to product X” in accordance with the model 171. In this case, the rule selection unit 130 decides the rule candidate as a new rule as illustrated in FIG. 14.

The derivation unit 140 determines that the risk state “Production cost of product X increases” can be derived by tracking the new rule and rules in the domain knowledge 161 from the start state “Law C is established” in FIG. 14.

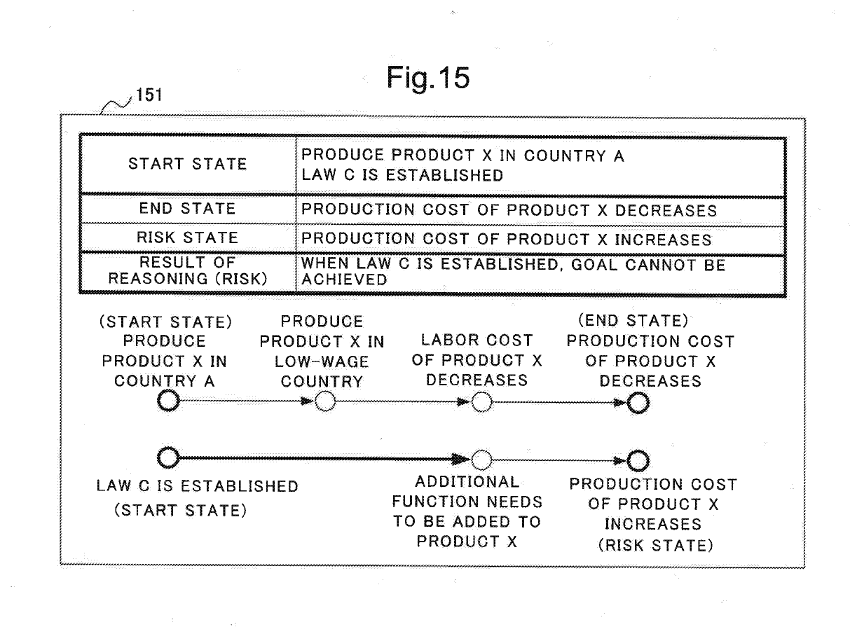

FIG. 15 is a diagram illustrating an example of an output screen 151 according to the second example embodiment of the present invention. In the example in FIG. 15, a new risk (“When law C is established, goal cannot be achieved”), which is a result of reasoning, and a derivation tree are displayed.

The output unit 150 displays the output screen 151 as illustrated in FIG. 15 to the user.

This allows the user to realize a new risk that cannot be found only from the known rules written in the domain knowledge 161. Further, by regularly watching news and official bulletins and inputting them as start states, risks relating to the new start states are presented and the user can make a quick decision.

### Specific Example 2: Action Support

As a specific example 2, an example of action support by the reasoning system 100 will be described next.

A case is considered here in which a route to a destination is proposed as action support. It is assumed that there are route A using a mountain path that is a shortcut with a short driving time, and route B using an arterial road that is a longer path with a long driving time. In this case, usually route A with a short driving time is selected only from a viewpoint of estimated arrival time, for example.

The reasoning system 100 extracts and presents a new risk that cannot be found only from known rules written in the domain knowledge 161 to support selecting a route.

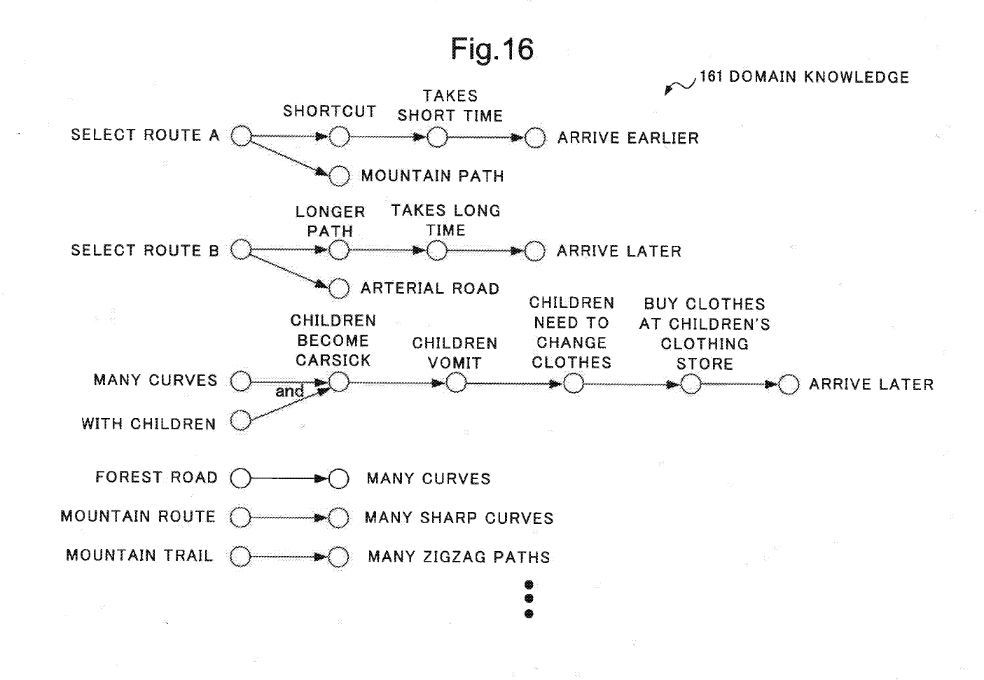

FIG. 16 is a diagram illustrating another example of domain knowledge 161 in the second example embodiment of the present invention. It is assumed that the domain knowledge 161 illustrated in FIG. 16 is stored in the domain knowledge storage unit 160.

It is also assumed that a model 171 learned based on the domain knowledge 161 in FIG. 16 is stored in the model storage unit 170. In this case, the model 171 has learned that a relation between states, “Route in mountains→Many curves” is likely to be feasible as a rule.

The input unit 110 receives input of “Select route A” and “With children” as start states from a user. Further, the input unit 110 receives an input of “Arrive earlier” as an end state from the user. The input unit 110 sets a negation state “Arrive later” for the input end state as a risk state.

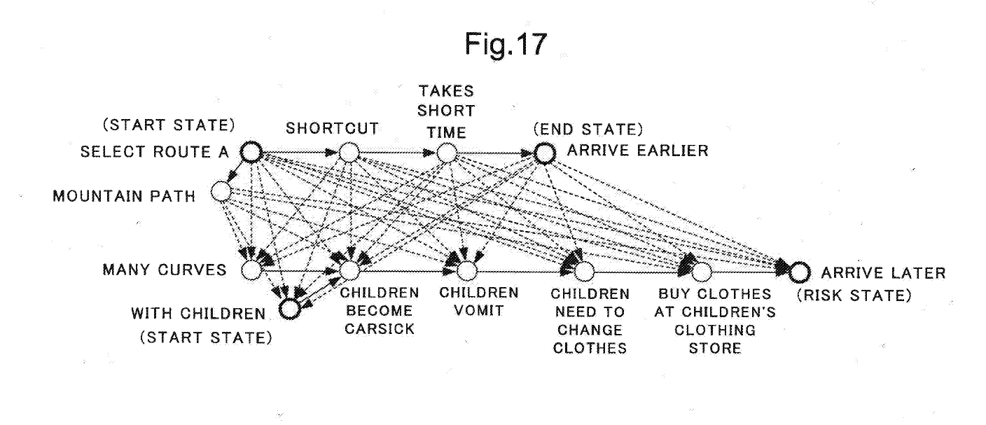

FIG. 17 is a diagram illustrating another example of generation of rule candidates according to the second example embodiment of the present invention.

As illustrated in FIG. 17, the rule candidate generation unit 120 identifies a state that can be obtained by tracking one or more rules from the start state “Select route A” in a forward direction and a state that can be obtained by tracking (backtracking) one or more rules from the risk state “Arrive later” in a backward direction. The rule candidate generation unit 120 then extracts each combination of the identified states as a rule candidate.

The rule selection unit 130 calculates a feasibility score for each rule candidate by using the model 171.

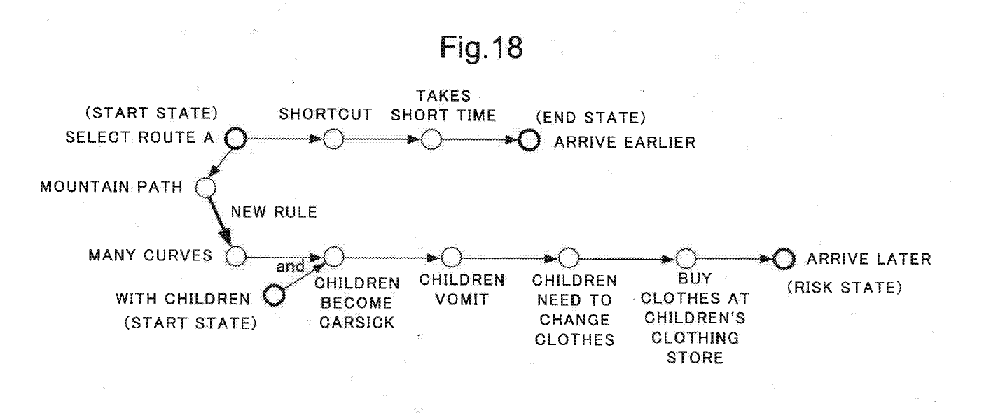

FIG. 18 is a diagram illustrating another example of determination of a new rule according to the second example embodiment of the present invention.

It is assumed here that a feasibility score equal to or more than a threshold has been calculated for a rule candidate “Mountain path→Many curves” in accordance with the model 171. In this case, the rule selection unit 130 decides the rule candidate as a new rule, as illustrated in FIG. 18.

The derivation unit 140 determines that the risk state “Arrive later” can be derived from the start state “Select route A” by tracking the new rule and rules in the domain knowledge 161 in FIG. 18.

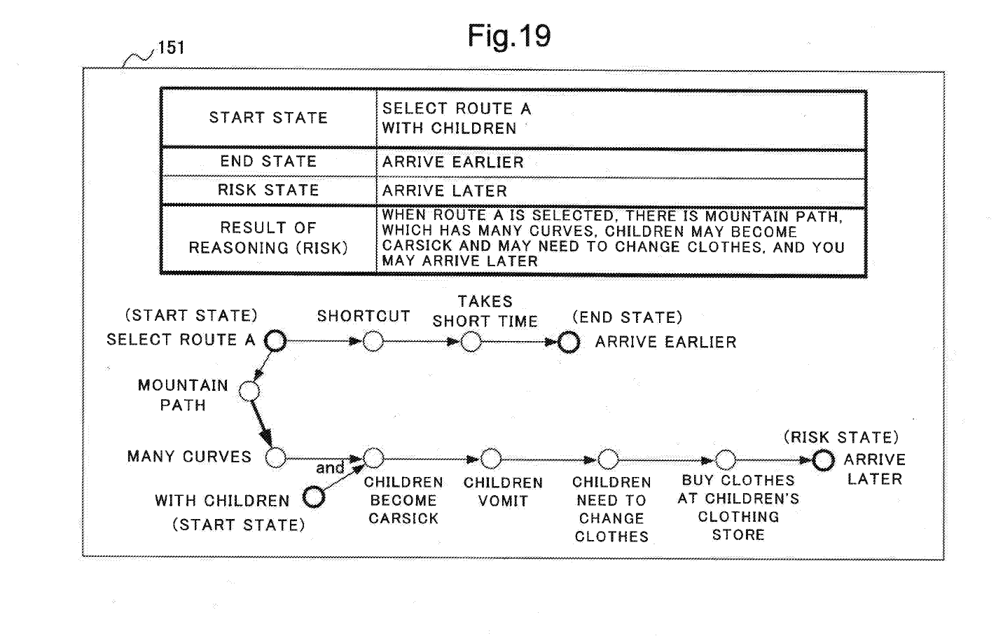

FIG. 19 is a diagram illustrating another example of the output screen 151 according to the second example embodiment of the present invention. In the example in FIG. 19, a new risk (“When route A is selected, there is a mountain path, which has many curves, children may become carsick . . . , and you may arrive later”), which is a result of reasoning, and a derivation tree are displayed.

In addition, the output screen 151 may display a recommendation to select route B, which is another route, and an advice, for example, to bring spare clothes for children when route A is selected.

The output unit 150 displays the output screen 151 as illustrated in FIG. 19 to the user.

This allows the user to realize the new risk that cannot be found only from known rules written in the domain knowledge 161. In addition, the user can obtain support appropriate for a situation, such as bringing spare clothes for children.

### Specific Example 3: Project Management Support

Lastly, as specific example 3, an example of project management support by the reasoning system 100 will be described.

Project management for system development ordered from company A will be considered here. In this system development, add-on development has occurred because required specifications are ambiguous. It is assumed that “Allocate additional budget and development personnel to thereby keep due date” has been designed as a project management plan.

The reasoning system 100 extracts and presents a new risk that cannot be found only from known rules written in the domain knowledge 161 to support project management.

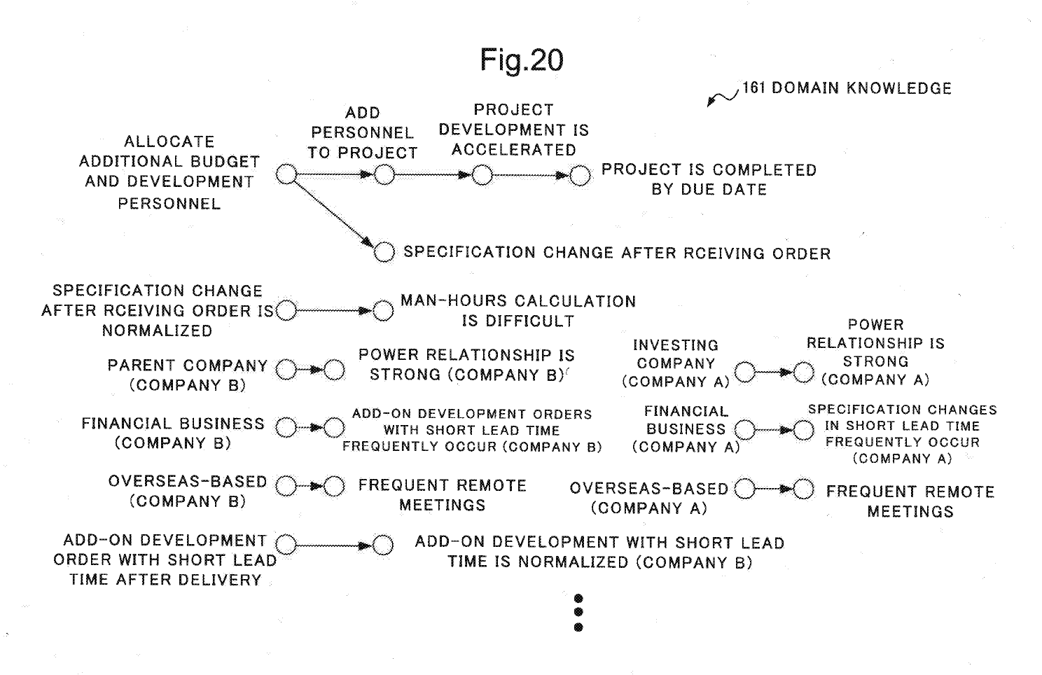

FIG. 20 is a diagram illustrating yet another example of the domain knowledge 161 according to the second example embodiment of the present invention. It is assumed that the domain knowledge 161 as illustrated in FIG. 20 is stored in the domain knowledge storage unit 160.

It is also assumed that a model 171 learned based on the domain knowledge 161 in FIG. 20 is stored in the model storage unit 170. In this case, the model 171 has learned that a relation between states, “Receive additional development from company x→Additional development from company x is normalized” is likely to be feasible as a rule.

The input unit 110 receives an input of “Allocate additional budget and development personnel” as a start state from a user. The input unit 110 also receives an input of “Development is completed by due date” as an end state from the user. The input unit 110 sets a risk state for the input end state, for example, “man-hours calculation is difficult” which is defined in association with a state “Development is completed by due date” in the domain knowledge storage unit 160.

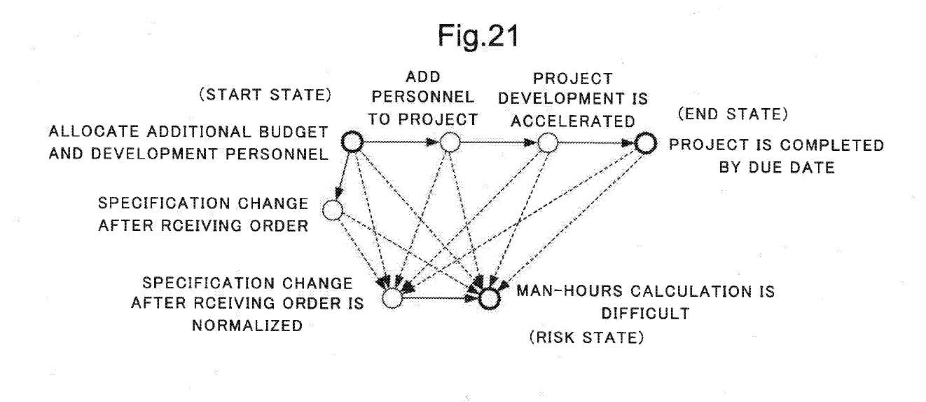

FIG. 21 is a diagram illustrating a yet another example of generation of rule candidates according to the second example embodiment of the present invention.

As illustrated in FIG. 21, the rule candidate generation unit 120 identifies a state that can be obtained by tracking one or more rules from the start state “Allocate additional budget and development personnel” in a forward direction and a state that can be obtained by tracking (backtracking) one or more rules from the risk state “Man-hours calculation is difficult” in a backward direction. The rule candidate generation unit 120 then extracts each combination of the identified states as a rule candidate.

The rule selection unit 130 calculates a feasibility score for each rule candidate by using the model 171.

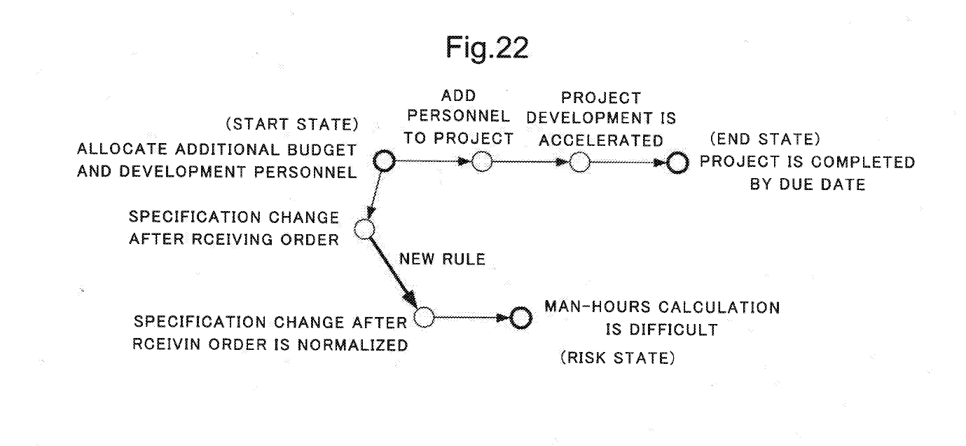

FIG. 22 is a diagram illustrating yet another example of determination of a new rule according to the second example embodiment of the present invention.

When the feasibility score of a rule candidate “Specification change after receiving order→Specification change after receiving order is normalized” is equal to or more than a threshold according to the model 171, the rule selection unit 130 decides the rule candidate as a new rule, as illustrated in FIG. 22.

In FIG. 22, the derivation unit 140 determines that the risk state “Man-hours calculation is difficult” can be derived by tracking the new rule and rules in the domain knowledge 161 from the start state “Allocate additional budget and development personnel”.

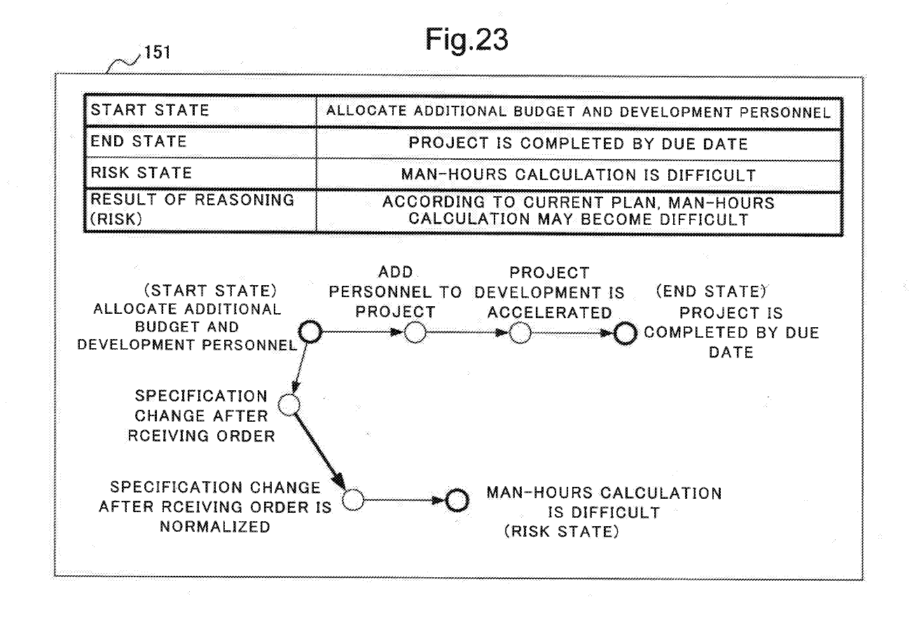

FIG. 23 is a diagram illustrating yet another example of the output screen 151 according to the second example embodiment of the present invention. In the example in FIG. 23, a new risk (“According to the current plan, man-hours calculation may become difficult”), which is a result of reasoning, and a derivation tree are displayed.

The output unit 150 displays the output screen 151 as illustrated in FIG. 23 to the user.

This allows the user to realize the new risk that cannot be found only from known rules written in the domain knowledge 161.

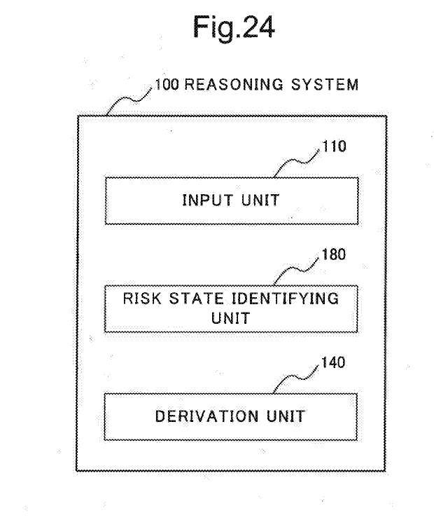

A characteristic configuration of the second example embodiment of the present invention will be described next. FIG. 24 is a block diagram illustrating a characteristic configuration of the second example embodiment of the present invention.

Referring to FIG. 24, a reasoning system 100 of the second example embodiment of the present invention includes an input unit 110, a risk state identifying unit 180, and a derivation unit 140.

The input unit 110 receives input of a start state and an end state.

The risk state identifying unit 180 identifies a risk state for the end state.

The derivation unit 140 performs a derivation process that derives the risk state from the start state, based on one or more known rules.

Advantageous effects of the second example embodiment of the present invention will be described next.

According to the second example embodiment of the present invention, idea conception support can be provided for a user. This is because the reasoning system 100 identifies a risk state for an end state, and performs a derivation process that derives the risk state from a start state based on known rules. As a result, information for conceiving a new idea (finding), such as a risk that cannot be found only from known rules and a basis thereof, can be presented to the user.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

### REFERENCE SIGNS LIST

100 Reasoning system
101 CPU
102 Storage device
103 Input/output device
104 Communication device
110 Input unit
120 Rule candidate generation unit
130 Rule selection unit
140 Derivation unit
150 Output unit
151 Output screen
160 Domain knowledge storage unit
161 Domain knowledge
170 Model storage unit
171 Model
180 Risk state identifying unit

1. A reasoning system comprising:
a memory storing instructions; and
one or more processors configured to execute the instructions to:
receive input of a start state and an end state;
identify a first state that is obtained by tracking one or more known rules from the start state and a second state that is obtained by backtracking one or more known rules from the end state, respectively, and generate a rule candidate relating to the first state and the second state or generate a rule candidate relating to the first state and a rule candidate relating to the second state;
select, based on feasibility of the generated rule candidate, the generated rule candidate as a new rule, the feasibility being calculated based on one or more known rules; and
perform a derivation process that derives the end state from the start state, based on one or more known rules and the new rule.

2. The reasoning system according to claim 1, wherein
the feasibility of the rule candidate is calculated based on similarity of a relation between states relating to the rule candidate with a relation between states relating to a known rule.

3. The reasoning system according to claim 2, wherein
the feasibility of the rule candidate is calculated as V₁^{T}·W·V₂, where V₁ is a vector representing one state relating to the rule candidate, V₂ is a vector representing another state relating to the rule candidate, and W is a weighting matrix, the weighting matrix being learned in such a way that high feasibility is indicated for the known rule.

4. The reasoning system according to claim 2, wherein
the feasibility of the rule candidate is calculated based on similarity between one state relating to the rule candidate and one state relating to the known rule, and similarity between another state relating to the rule candidate and another state relating to the known rule.

5. The reasoning system according to claim 1,
rule candidates are generated for respective combinations of each of one or more of the first states and each of one or more of the second states, and
the new rule is selected from among the generated rule candidates, based on the feasibility of each of the generated rule candidates.

6. The reasoning system according to claim 5, wherein the new rule is selected from among rule candidates excluding a rule candidate relating to a negated state among the rule candidates.

7. The reasoning system according to claim 1, wherein
the one or more processors configured to further execute the instructions to display a derivation tree indicating one or more rules from the start state to the end state.

8. The reasoning system according to claim 7, wherein
the one or more processors configured to further execute the instructions to: output, in the derivation tree, the new rule and one or more known rules in different styles from each other.

9. The reasoning system according to claim 1, wherein
the one or more processors configured to further execute the instructions to: receive designation of a rule candidate to be selected as the new rule among the generated rule candidates, and
select the designated rule candidate as the new rule.

10. The reasoning system according to claim 1, wherein
the one or more processors configured to further execute the instructions to: collect and set the start state from a predetermined information source.

11. The reasoning system according to claim 1, wherein
the rule defines a relation in which one state relating to the rule is a premise and another state relating to the rule is a conclusion.

12. A reasoning method comprising:
receiving input of a start state and an end state;
identifying a first state that is obtained by tracking one or more known rules from the start state and a second state that is obtained by backtracking one or more known rules from the end state, respectively, and generating a rule candidate relating to the first state and the second state or generating a rule candidate relating to the first state and a rule candidate relating to the second state;
selecting, based on feasibility of the generated rule candidate, the generated rule candidate as a new rule, the feasibility being calculated based on one or more known rules; and
performing a derivation process that derives the end state from the start state, based on one or more known rules and the new rule.

13. A non-transitory computer readable storage medium recording thereon a program causing a computer to perform a method comprising:
receiving input of a start state and an end state;
identifying a first state that is obtained by tracking one or more known rules from the start state and a second state that is obtained by backtracking one or more known rules from the end state, respectively, and generating a rule candidate relating to the first state and the second state or generating a rule candidate relating to the first state and a rule candidate relating to the second state;
selecting, based on feasibility of the generated rule candidate, the generated rule candidate as a new rule, the feasibility being calculated based on one or more known rules; and
performing a derivation process that derives the end state from the start state, based on one or more known rules and the new rule.

14-19. (canceled)
